(19) United States
(12) Patent Application Publication
(10) Pub. No.: US 2016/0331623 A1
(43) Pub. Date: Nov. 17, 2016

(54) LOWER EXTREMITY SUPPORT TOOL

(71) Applicant: PANASONIC CORPORATION, Kadoma-shi (JP)

(72) Inventors: Kazuhiro NAKATANI, Hyogo (JP); Makoto KONISHI, Osaka (JP); Hiromichi FUJIMOTO, Nara (JP)

(21) Appl. No.: 15/111,281

(22) PCT Filed: Oct. 22, 2014
(86) PCT No.: PCT/JP2014/005368

§ 371 Date: Jul. 13, 2016

(30) Foreign Application Priority Data
Jan. 15, 2014 (JP) 2014-005182
Jan. 17, 2014 (JP) 2014-006902

(51) Int. Cl. A61H 1/02; A61H 3/00

(52) U.S. Cl. CPC A61H 1/0244; A61H 3/00; A61H 2003/0211

(57) ABSTRACT

A lower extremity support tool includes: a right and a left foot parts, a right and a left leg parts, a lower back part disposed in an area of a lower back of the user, the lower back part rotatably supporting individually each of the right and the left leg parts, the lower back part including a right and a left motors each causing one of the right and the left leg parts to normally rotate or reversely rotate; and a control part that controls the normal rotation and the reverse rotation of each of the the right and the left motors in the lower back part.

### TECHNICAL FIELD

This disclosure relates to a lower extremity support tool to which a passive dynamic walk mechanism (a passive mechanism) is applied.

### BACKGROUND ART

A large number of apparatuses are present that each aim at aiding walking. For example, such apparatuses are present as an apparatus that aids an walking action using actuators as shown in Japanese Patent Laid-Open Publication No. 2004-344304 referred as Patent Document 1, Japanese Patent Laid-Open Publication No. 2004-344305 referred as Patent Document 2, and Japanese Patent Laid-Open Publication No. 2004-344306 referred as Patent Document 3 and a walking aid apparatus that aids knees and ankles as shown in Japanese Patent Laid-Open Publication No. 2011-142958 referred as Patent Document 4.

A walking aid apparatus is further present that stretches or shortens the length of each of its right and left posts supporting the body weight of a person having difficulty of ambulation such as paralysis in the lower extremities for the one of the posts to alternately be longer than the other post such that the person is provided with a unit for the person to independently walk as shown in Japanese Patent Laid-Open Publication No. 4-352961 referred as Patent Document 5.

### SUMMARY

The walking aid apparatuses described in the above Patent Documents are each an apparatus that actively aids the walking action and each of the knees, the lower back, and the like is provided with an actuator. The weight thereof is therefore heavy and a large amount of electric power is necessary.

An object of the present invention is to provide a lower extremity support tool for aiding walking, that facilitates reduction of the weight and that can realize electric power saving.

In one general aspect, the techniques disclosed here feature: a lower extremity support tool includes:

a right and a left foot parts, each includes a curved face on a back face thereof facing a ground surface, the right and the left foot parts each having one foot of both of feet of a user individually placed thereon on a front face thereof;

a right and a left leg parts, the right leg part being connected to the right foot part, the left leg part being connected to the left foot part, the right and the left leg parts each extending along an area of one of both legs of the user;

a lower back part disposed in an area of a lower back of the user, the lower back part rotatably supporting individually each of the right and the left leg parts, the lower back part comprising a right and a left motors each causing one of the right and the left leg parts to normally rotate or reversely rotate; and

a control part that controls the normal rotation and the reverse rotation of each of the the right and the left motors in the lower back part, while the curved face of the back face of one of the foot parts faces the ground surface to grab the ground surface, the one of the foot parts being connected to one of the leg parts, such that the motor causes the other of the leg parts to normally rotate when the other of the leg parts kicks the ground surface back ward, or the motor causes the other of the leg parts to reversely rotate when the other leg part is swung forward, wherein

walking by a passive walk mechanism is realized, the curved faces of the back faces of the right and the left foot parts alternately facing the ground surface to grab the ground surface alternately in the passive walk mechanism.

According to the lower extremity support tool of this disclosure, the normal rotation and the reverse rotation of each of the motors of the lower back part are controlled, while the curved face of the back face of one of the foot parts faces the ground surface to grab the ground surface, the one of the foot parts being connected to one of the leg parts, such that the motor causes the other of the leg parts to normally rotate when the other of the leg parts kicks the ground surface back ward, or the motor causes the other of the leg parts to reversely rotate when the other leg part is swung forward.

The walking can thereby be realized by the passive walk mechanism. It is noted that the curved faces of the back faces of the right and the left foot parts alternately facing the ground surface to grab the ground surface alternately in the passive walk mechanism.

According to the lower extremity support tool of this disclosure, because no actuator is disposed in the knee parts, compared to the case where an actuator is disposed in each of the knee parts and the lower back part, the overall weight can be reduced and the power consumption can be reduced to extend the time period for the battery to be usable.

### BRIEF DESCRIPTION OF DRAWINGS

FIG. 1 is a schematic view of an overview of a lower extremity support tool according to a first embodiment.

FIG. 2 is a block diagram of a configuration of the lower extremity support tool according to the first embodiment.

FIG. 3 is a block diagram of one example of a configuration of a control part of the lower extremity support tool according to the first embodiment.

FIG. 4 is a schematic view of various examples of a curvature radius R of a curved face of a back face of a foot part of FIG. 1.

FIG. 5(a) is an image of walking of a user that wears the lower extremity support tool according to the first embodiment, and FIG. 5(b) is a schematic view of states of normal rotation and reverse rotation of a motor 15a of a right foot, that corresponds to the image of the walking of FIG. 5(a).

### DETAILED DESCRIPTION

As a lower extremity support tool of a first aspect, a lower extremity support tool includes:

a right and a left foot parts, each includes a curved face on a back face thereof facing a ground surface, the right and the left foot parts each having one foot of both of feet of a user individually placed thereon on a front face thereof;

a right and a left leg parts, the right leg part being connected to the right foot part, the left leg part being connected to the left foot part, the right and the left leg parts each extending along an area of one of both legs of the user;

a lower back part disposed in an area of a lower back of the user, the lower back part rotatably supporting individually each of the right and the left leg parts, the lower back part comprising a right and a left motors each causing one of the right and the left leg parts to normally rotate or reversely rotate; and

a control part that controls the normal rotation and the reverse rotation of each of the the right and the left motors in the lower back part, while the curved face of the back face of one of the foot parts faces the ground surface to grab the ground surface, the one of the foot parts being connected to one of the leg parts, such that the motor causes the other of the leg parts to normally rotate when the other of the leg parts kicks the ground surface back ward, or the motor causes the other of the leg parts to reversely rotate when the other leg part is swung forward, wherein

walking by a passive walk mechanism is realized, the curved faces of the back faces of the right and the left foot parts alternately facing the ground surface to grab the ground surface alternately in the passive walk mechanism.

As a lower extremity support tool of a second aspect, in the first aspect, a curvature radius of the curved face of the back face of the foot part may be equal to or larger than a distance from an ankle of the user to the back face of the foot part, and may be equal to or smaller than a distance from a center of gravity of the lower extremity support tool during use thereof to the back face of the foot part.

As a lower extremity support tool of a third aspect, in the first or second aspect, the control part may control the normal rotation or the reverse rotation of each of the right and the left motors according to an image of walking of the user.

As a lower extremity support tool of a fourth aspect, in any one of the first to third aspect, the leg parts each may include:

a lower leg part of the foot part;

an upper leg part of the lower back part; and

a knee part that foldably connects the lower leg part and the upper leg part to each other.

As a lower extremity support tool of a fourth aspect, in the fourth aspect, the knee part of the leg part may include a backstop mechanism that deters any rotation of the lower leg part heading forward around the knee part.

<Details of Acquisition of One Embodiment According to This Disclosure>

To facilitate reduction of the weight of a lower extremity support tool, the inventor studied about omitting either actuators disposed in knee parts thereof or actuators disposed in a lower back part thereof. In this case, taking into consideration the functions of the actuators disposed in the knee parts and the lower back part, it was considered that the actuators disposed in the lower back part were indispensable. It was however found that, when only the actuators disposed in the lower back part were used, though kicking backward and swinging forward of each of the leg parts were able to be executed, any active control for the portion under each of the knee parts was unable because the actuators in the knee parts were omitted, resulting in difficulty in smoothly moving the overall body forward or backward only with those actuators.

By the way, a bipedal walking toy has been known that walks down a slope without using any motor. The walk mechanism of such a bipedal walking toy or a bipedal walking robot is referred to as “passive walking” (also referred to as “passive dynamic walking”) in contrast to the active walking that uses actuators as shown in “Demonstration and Analysis of Qadrupedal Passive Dynamic Walking”, Kazuhiro Nakatani, Yasuhiro Sugimoto, and Koichi Osuga, The Robotics Society of Japan, Advanced Robotics, 2009, Volume 23, Issue 5, pp. 483-501 referred as Non-Patent Literature 1. The passive walking is excellent in the energy efficiency because the passive walking does not use any actuator and operates using only the potential energy on a slope or the like. It is furthermore said that the gait (the stride) thereof appears to be natural.

The passive walking toy, robot, or the like can not be caused to walk on a flat ground on which no potential energy is usable though the toy, the robot, or the like can walk down a slope. The passive walking has been applied only to toys and robots and it has not been considered that the passive walking is applied to aiding for walking of a human. It has not traditionally been considered at all furthermore that the passive walking and the aiding for walking using actuators are combined with each other for an assist suit or the like used in aiding for walking of a human even in the case where the actuators are used.

The inventor variously studied seeking to combine the above passive walk mechanism with a lower extremity support tool, and completed the present invention.

The lower extremity support tool to which a passive mechanism is applied according to the embodiment of this disclosure will be described below with reference to the accompanying drawings. In the drawings, the substantially same members are given the same reference numerals.

### First Embodiment

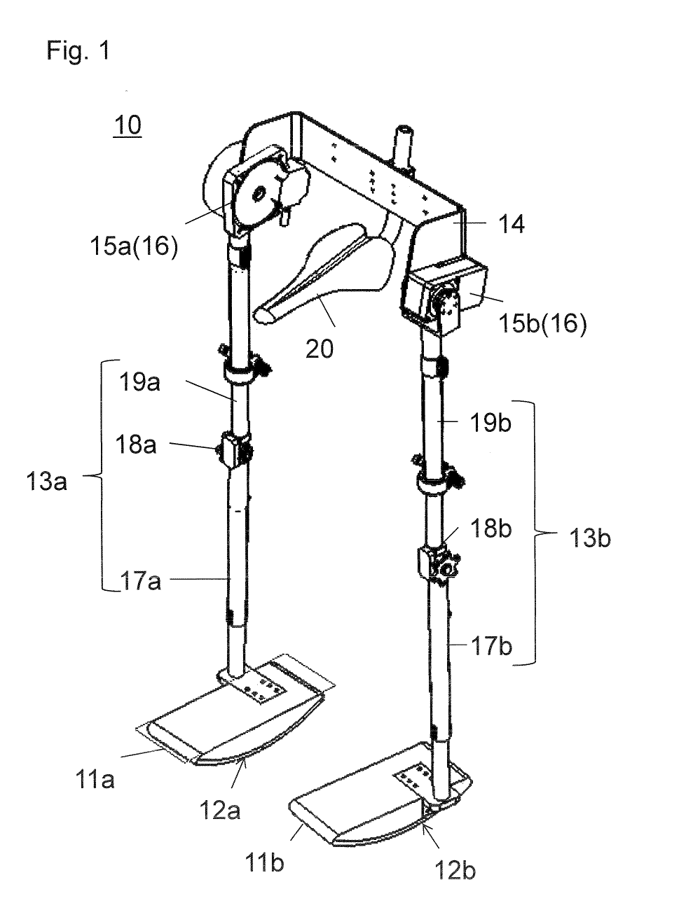

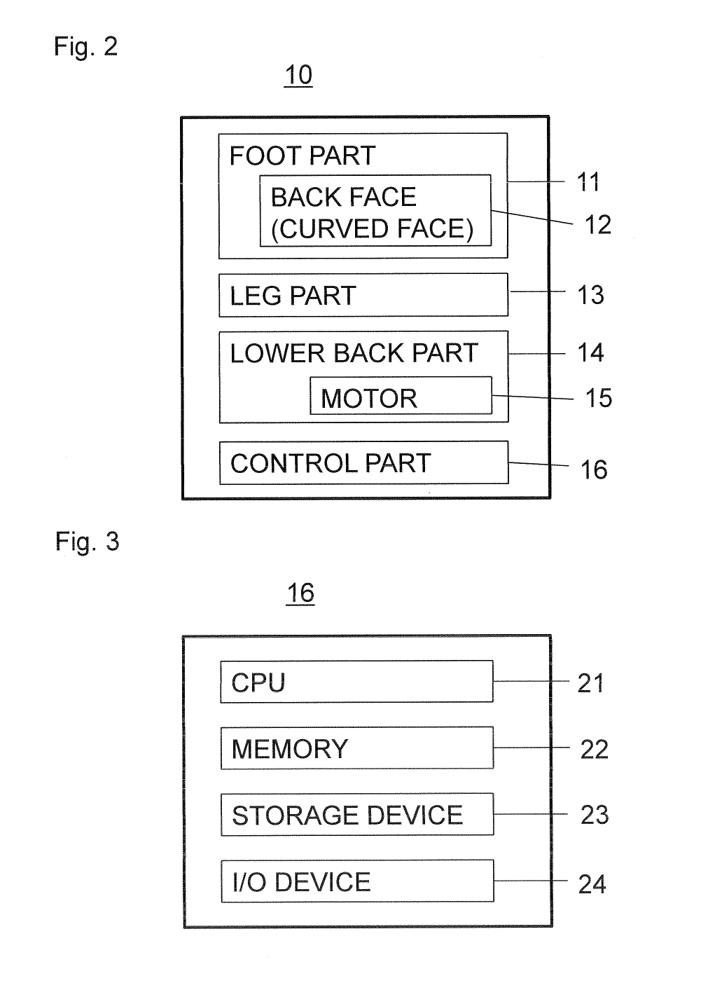

FIG. 1 is a schematic view of an overview of the lower extremity support tool 10 according to the first embodiment. FIG. 2 is a block diagram of a configuration of the lower extremity support tool 10 according to the first embodiment. FIG. 3 is a block diagram of one example of a configuration of a control part 16 of the lower extremity support tool according to the first embodiment.

The lower extremity support tool 10 to which the passive mechanism is applied includes a right and a left foot parts 11a and 11b, a right and a left leg parts 13a and 13b, a lower back part 14, and the control part 16. Each of the right and the left foot parts 11a and 11b has a curved face on a back face thereof that faces the ground surface, and has one of both feet of a user individually placed thereon on a front face thereof. The right and the left leg parts 13a and 13b are each connected to the corresponding foot part of both of the right and the left foot parts, and each extend along an area of the corresponding leg of both of the legs of the user. The lower back part 14 is disposed in an area of the lower back of the user, rotatably supports individually each of the right and the left leg parts 13a and 13b, and includes a right and a left motors 15a and 15b that respectively cause the right and the left leg parts 13a and 13b to normally rotate and reversely rotate. The control part 16 controls the normal rotation and the reverse rotation of each of the motors 15a and 15b in the lower back part 14, while the curved face of the back face of one of the foot parts faces the ground surface to grab the ground surface, the one of the foot parts being connected to one of the leg parts, such that the motor causes the other of the leg parts to normally rotate when the other leg part kicks the ground surface backward, or the motor causes the other of the leg parts to reversely rotate when the other leg part is swung forward. The walking can thereby be realized by the passive walk mechanism, the curved faces of the back faces 12a and 12b of the right and the left foot parts 11a and 11b alternately face the ground surface to grab the ground surface alternately in the passive walk mechanism with reducing the load on the user.

The “walking by the passive walk mechanism” refers to walking executed in a natural gait by controlling the kicking backward and swinging forward of each of the leg parts 13a and 13b by only controlling the normal rotation and the reverse rotation of each of the motors 15a and 15b of the lower back part 14. In this case, the back faces 12a and 12b of the right and the left foot parts 11a and 11b alternately grab the ground surface along the curved faces of the back faces of the right and the left parts 11a and 11b.

According to the lower extremity support tool 10, because no actuator is disposed in the lower back part, compared to the case where actuators are disposed in the knee parts and the lower back part, the overall weight can be reduced. Because no actuator is disposed in the knee parts, the power consumption can be suppressed and the time period for the battery to be usable can be extended.

Constituent members constituting the lower extremity support tool 10 will be described.

<Foot Part>

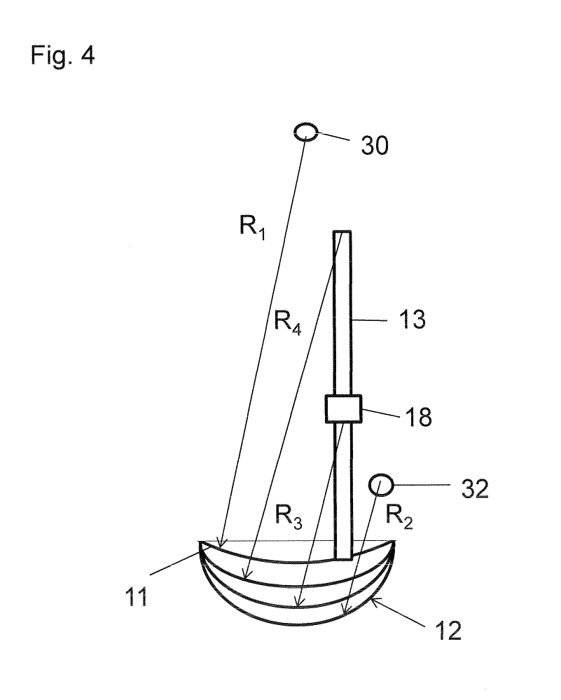

The curved faces 12a and 12b to grab the ground surface are respectively disposed on the back faces of the right and the left foot parts 11a and 11b. Because the ground surface can be grabbed along the curved faces of the back faces 12a and 12b, the walking image can be set to be natural. FIG. 4 is a schematic view of various examples of the curvature radius R of each of the curved faces of the back faces of the foot parts of FIG. 1. The curvature radius R of each of the curved faces 12a and 12b may be, for example, equal to or smaller than a distance R₁ from the center of gravity 30 during the use to the back faces 12 of the foot parts 11 (11a and 11b). The curvature radius R may further be equal to or larger than a distance R₂ from ankles 32 of the user to the back faces 12 of the foot parts 11 (11a and 11b). In addition, the curvature radius R may be, for example, a distance R₃ from the knee parts 18 to the back faces 12 (12a and 12b) of the foot parts 11 (11a and 11b), or a distance R₄ from connection points of the leg parts 13 (13a and 13b) and the lower back part 14 to each other, to the back faces 12 (12a and 12b) of the foot parts 11 (11a and 11b). As depicted in FIG. 4, the thickness of each of the back faces 12 of the foot parts 11 is varied corresponding to the magnitude of the curvature radius R.

As above, the energy efficiency can be improved by setting the curvature radius of the curved faces disposed in the back faces to be the curvature radius R of the length equal to or smaller than the distance R₁ from the center of gravity during the use to the back faces. The front face of the foot parts 11a and 11b each have the foot of the user placed thereon. In this case, the front face may properly have a shape or the like suitable for having the foot placed thereon.

<Leg Part>

Each of the right and the left leg parts 13a and 13b is connected at one end thereof to the corresponding one of the foot parts 11a and 11b of both of the feet, and at the other end thereof to the lower back part 14. The leg parts 13a and 13b each extend along an area of the corresponding one of both legs of the user. The leg parts 13a and 13b may include lower leg parts 17a and 17b of the foot parts, upper leg parts 19a and 19b of the lower back part, and knee parts 18a and 18b that foldably connect the lower leg parts 17a and 17b, and the upper leg parts 19a and 19b respectively to each other. The knee parts 18a and 18b may include backstop mechanisms (not depicted) that respectively deter any rotations of the lower leg parts 17a and 17b heading forward around the knee parts 18. This can avoid the state of the lower extremity support tool 10 where any reverse rotation of each of the knee parts occurs that cannot be realized by the knees of the user, and the lower extremity support tool 10 can be safely used.

<Lower Back Part>

The lower back part 14 is disposed in an area of the lower back of the user to rotatably support individually each of the right and the left leg parts 13a and 13b. The lower back part 14 includes the right and the left motors 15a and 15b that respectively cause the right and the left leg parts 13a and 13b to each normally rotate and reversely rotate. The motors 15a and 15b only have to be motors capable of rotating normally and reversely. The control part 16 controls the normal rotation and the reverse rotation of the motor 15b (15a) in the lower back part 14, while the curved face of the back face 12a (12b) of one of the foot parts 11a (11b) faces the ground surface to grab the ground surface, the one of the foot parts being connected to one of the leg parts, such that the motor causes the other of the leg parts to normally rotate when the other leg part 13b (13a) kicks the ground surface backward, or the motor causes the other of the leg parts to reversely rotate when the other leg part is swung forward. The other leg part 13b (13a) is opposite to one leg part 13a (13b) connected to the one foot part 11a (11b).

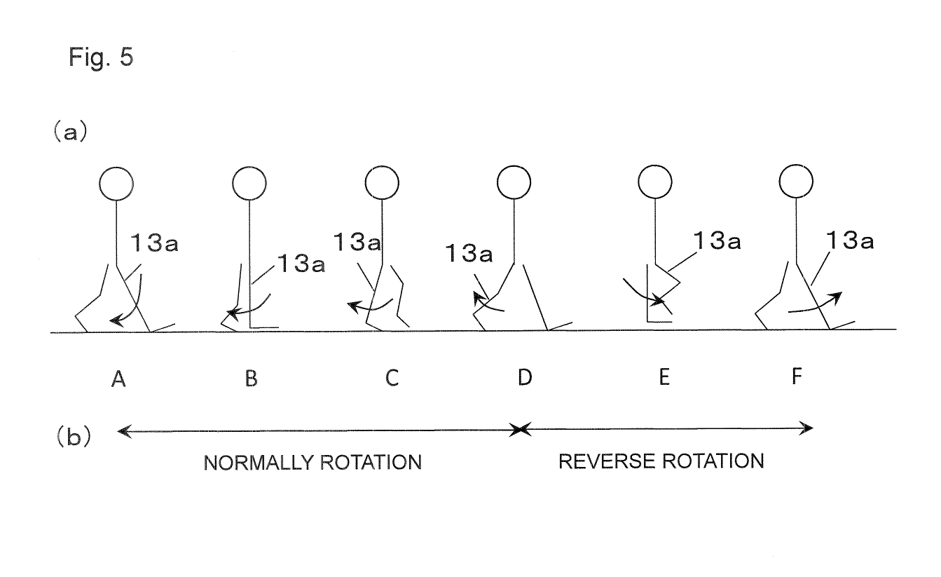

FIG. 5(a) is an image of walking of the user that wears the lower extremity support tool 10 according to the first embodiment. FIG. 5(b) is a schematic view of control states for the normal rotation and the reverse rotation of a motor 15a of the right foot, that corresponds to the image of the walking of FIG. 5(a). The image of the walking is an image that depicts the ordinary gait of the user or the gait demanded by the user. The image of the walking of FIG. 5(a) is an image of walking to be an index to acquire the demanded gait reducing the load on the user by aiding the walking using the lower extremity support tool 10 according to the first embodiment. Though FIG. 5(a) depicts the image of the walking on a flat ground, the image of walking is not limited to this and may be an image of walking for the case where the lower extremity support tool 10 is used to go up or down a sloping road. The lower extremity support tool 10 includes only the motors 15a and 15b to normally rotate or reversely rotate the leg parts 13a and 13b in the lower back part 14, and includes no actuator in the knee parts 18. No active control therefore cannot be executed for the portions under the knee parts. In this case, in the image of the walking of FIG. 5(a), it can be considered that the portions under the knee parts are not positioned ahead of the knee parts while, similarly to the case of the ordinary walking, even the portions under the knee parts can be positioned in front of or behind the knee parts using the inertial forces generated along the flow of the series of walking steps. The gait can thereby be caused to approach that of the natural walking.

The image of the walking of FIG. 5(a) will be described. In a walking step image A, the left foot acts as the pivot foot and kicks the ground surface backward, and the heel of the foot part 11a of the right foot to be the idling foot contacts the ground surface, then, the right foot becomes the pivot foot. In a walking step image B, the foot bottom of the foot part 11a on the right foot to be the pivot foot contacts the ground surface. In this case, the heel first contacts and the foot bottom thereafter contacts the ground surface. The leg part 13b on the left foot to be the idling foot is swung forward. In a walking step image C, the leg part on the right foot to be the pivot foot kicks the ground surface backward. In a walking step image D, the tiptoe of the foot part 11a on the right foot leaves the ground surface, then, the right foot become the idling foot. Immediately before this, the heel of the foot part 11b on the right foot contacts the around surface, then, the left foot become the pivot foot. In a walking step image E, the leg part 13a on the right foot to be the idling foot is swung forward. In a walking step image F (same as the walking step image A), the heel of the foot part 11a on the right foot to be the idling foot contacts the ground surface.

Noting the leg part 13a on the right foot, as depicted in FIG. 5(a), in the walking step images A to D, the control part 16 controls the motor 15a to normally rotate such that the leg part 13a on the right foot normally rotates clockwise to kick the ground surface backward. On the other hand, in the walking step images D to F, the control part 16 controls the motor 15a to reversely rotate such that the leg part 13a on the right foot reversely rotates counterclockwise for the leg part 13a to be swung forward. The user can easily move his/her right foot along with the normal rotation and the reverse rotation of the motor 15a to be able to reduce the load. As above, the control of the normal rotation and the reverse rotation of the motor 15a only has to be executed corresponding to the image of the walking of (a) of FIG. 5. Otherwise, the normal rotation and the reverse rotation of the motor 15a may be switched therebetween at constant timings (period).

In this manner, the motors 15a and 15b of the lower back part 14 are sequentially controlled to normally rotate and reversely rotate, and the walking can thereby be realized by the passive walk mechanism that grabs the ground surface alternately using the back faces of the right and the left foot parts 11a and 11b along the curved faces of the back faces 12a and 12b of the right and the left foot parts 11a and 11b. When the ground surface is grabbed along the curved faces of the back faces 12a and 12b of the right and the left foot parts 11a and 11b, the walking can smoothly be executed.

In the case where the back faces 12a and 12b of the right and the left foot parts 11a and 11b contact the ground surface, when the ground surface is continuously grabbed along the curved faces of the back faces 12a and 12b, the walking can more smoothly be executed and the effect of the passive walking can more easily be achieved.

Intermittent contact with the ground surface can also be executed by contacting the ground surface using only the portions each corresponding to the plantar arch in the curved faces of the back faces 12a and 12b of the right and the left foot parts 11a and 11b. In this case, the smoothness of the walking is degraded while the effect of the passive walking similar to that of the above can be achieved.

Otherwise, in each of the back faces 12a and 12b, not the one curved face but plural curved faces may be disposed to contact the ground surface using a virtual curved face formed by the protrusions of the curved faces. In this case, the walking can smoothly be executed and the effect of the passive walking can also be achieved by sequentially executing the intermittent contact with the ground surface using the protrusions of the curved surfaces. Because the contact with the ground surface is executed using the protrusions of the curved surfaces through point contact, no influence from the ground surface tends to be received.

According to the lower extremity support tool to which the passive mechanism is applied of this disclosure, because no actuator is disposed in the knee parts, the lower extremity support tool is useful for the uses of a walking aid lower extremity support tool capable of reducing the weight thereof and realizing electric power saving.

### EXPLANATIONS OF LETTERS OR NUMBERS

10 lower extremity support tool
11, 11a, 11b foot part
12, 12a, 12b back face (curved face)
13, 13a, 13b leg part
14 lower back part
15, 15a, 15b motor
16 control part
17, 17a, 17b lower leg part
18, 18a, 18b knee part
19, 19a, 19b upper leg part
20 saddle
21 CPU
22 memory
23 storage device
24 input and output device
30 center of gravity
32 ankle

1. A lower extremity support tool comprising:
a right and a left foot parts, each comprises a curved face on a back face thereof facing a ground surface, the right and the left foot parts each having one foot of both of feet of a user individually placed thereon on a front face thereof;
a right and a left leg parts, the right leg part being connected to the right foot part, the left leg part being connected to the left foot part, the right and the left leg parts each extending along an area of one of both legs of the user;
a lower back part disposed in an area of a lower back of the user, the lower back part rotatably supporting individually each of the right and the left leg parts, the lower back part comprising a right and a left motors each causing one of the right and the left leg parts to normally rotate or reversely rotate; and
a control part that controls the normal rotation and the reverse rotation of each of the the right and the left motors in the lower back part, while the curved face of the back face of one of the foot parts faces the ground surface to grab the ground surface, the one of the foot parts being connected to one of the leg parts, such that the motor causes the other of the leg parts to normally rotate when the other of the leg parts kicks the ground surface back ward, or the motor causes the other of the leg parts to reversely rotate when the other leg part is swung forward, wherein
walking by a passive walk mechanism is realized, the curved faces of the back faces of the right and the left foot parts alternately facing the ground surface to grab the ground surface alternately in the passive walk mechanism.

2. The lower extremity support tool according to claim 1, wherein
a curvature radius of the curved face of the back face of the foot part is equal to or larger than a distance from an ankle of the user to the back face of the foot part, and is equal to or smaller than a distance from a center of gravity of the lower extremity support tool during use thereof to the back face of the foot part.

3. The lower extremity support tool according to claim 1, wherein
the control part controls the normal rotation or the reverse rotation of each of the right and the left motors according to an image of walking of the user.

4. The lower extremity support tool according to claim 1, wherein
the leg parts each comprises:
a lower leg part of the foot part;
an upper leg part of the lower back part; and
a knee part that foldably connects the lower leg part and the upper leg part to each other.

5. The lower extremity support tool according to claim 4, wherein
the knee part of the leg part comprises a backstop mechanism that deters any rotation of the lower leg part heading forward around the knee part.
